(19) United States
(12) Patent Application Publication
(10) Pub. No.: US 2010/0122611 A1
(43) Pub. Date: May 20, 2010

(54) SOCKET WRENCH

(76) Inventor: Melvin Everett, Valdosta, GA (US)

Correspondence Address: JAY M. SCHLOFF, 6960 Orchard Lake Road, Suite 315, West Bloomfield, MI, 48322, US

(21) Appl. No.: 12/537,642

(22) Filed: Aug. 7, 2009

Related U.S. Application Data
(60) Provisional application No. 61/114,756, filed on Nov. 14, 2008.

(51) Int. Cl. B25B 13/06

(52) U.S. Cl. 81/125

(57) ABSTRACT

A socket wrench for driving a fastener associated with an electrical line is provided. The socket wrench includes a socket member and a handle member. The socket member has a proximal end portion and a distal end portion. The socket member includes a socket head and a base member. The socket head extends between the proximal end portion and the distal end portion of the socket member. The socket head is configured to receive the fastener. The base member is configured at the distal end portion of the socket member. The base member has an aperture configured therein. The aperture allows the electrical line to pass therethrough. The handle member extends from the distal end portion of the socket member. The handle member is substantially hollow to allow the electrical line to pass therethrough.

### CROSS-REFERENCE TO RELATED APPLICATIONS

The present disclosure claims priority under 35 United States Code, Section 119 on the U.S. Provisional Patent Application No. 61/114,756 filed on Nov. 14, 2008 the disclosure of which is incorporated by reference.

### FIELD OF THE DISCLOSURE

The present disclosure generally relates to wrenches, and more particularly, to a socket wrench for use in driving fasteners associated with electrical lines.

### BACKGROUND OF THE DISCLOSURE

Wrenches are utilized for locking, unlocking, tightening and loosening (hereinafter collectively referred to as driving) fasteners such as nuts, bolts, and other articles adapted to interface with wrenches. Specifically, the wrenches reduce the amount of effort required for driving fasteners. Currently, a variety of wrenches are available in the market. Examples of such wrenches include an open-end wrench, a box-end wrench, an adjustable wrench, a socket wrench and the like.

An application of a conventional socket wrench includes driving fasteners installed in electrical enclosures. The fasteners installed in electrical enclosures are generally connected to electrical lines. However, using the conventional socket wrench for driving such fasteners installed on electrical lines has a few disadvantages. Firstly, the electrical lines pose a hindrance in accessing the fastener for the purpose of driving. Frequently due to such hindrance, it becomes difficult for the fasteners installed in the electrical enclosures to be accessed by the conventional socket wrench. In order to avoid this hindrance, the electrical lines are required to be cut or disengaged. The cutting or disengaging of electrical lines is undesirable since it may be laborious and dangerous for an individual handling the conventional socket wrench. Also, the cutting of the electrical lines may lead to added effort of re-engaging the electrical lines, after the driving of the fasteners installed on the electrical lines is completed.

Moreover, electrical enclosures that accommodate electrical lines are usually compact and accommodate a large number of fasteners installed on the electrical lines. Utilization of a conventional socket wrench for driving fasteners in such compact electrical enclosures often leads to inadvertent contact of the socket wrench with other components installed within the electrical enclosures. Further, due to the relatively large size of the conventional socket wrench, holding the fastener with the socket wrench and thereafter driving the fastener may become difficult since the large sized socket wrench may interfere with other components installed within the electrical enclosures.

Accordingly, there exists a need for a socket wrench for driving fasteners installed on electrical lines without cutting or disengaging the electrical lines. Further, there exists a need for a socket wrench that is capable of driving fasteners installed in the confined spaces such as compact electrical enclosures that accommodate the electrical lines.

### SUMMARY OF THE DISCLOSURE

In view of the foregoing disadvantages inherent in the prior art, the general purpose of the present disclosure is to provide a socket wrench for driving fasteners associated with electrical lines that is configured to include all the advantages of the prior art, and to overcome the drawbacks inherent therein.

Accordingly, an object of the present disclosure is to provide a socket wrench that is capable of driving fasteners, such as nuts, bolts associated with electrical lines without cutting or disengaging the electrical lines.

Another object of the present disclosure is to provide a socket wrench that is capable of driving fasteners associated with electrical lines in confined spaces, such as compact electrical enclosures that accommodate the electrical lines

Yet another object of the present disclosure is to provide a socket wrench that facilitates driving of fasteners, such as nuts, in a safe, convenient, reliable, user-friendly, and cost effective manner.

To achieve the above objects, in an aspect of the present disclosure, a socket wrench is provided that is capable of driving a fastener associated with an electrical line. The socket wrench includes a socket member and a handle member. The socket member has a proximal end portion and a distal end portion. The socket member includes a socket head and a base member. The socket head extends between the proximal end portion and the distal end portion of the socket member. The socket head is configured to receive the fastener. The base member is configured at the distal end portion of the socket member. The base member has an aperture configured therein. The aperture allows the electrical line to pass therethrough. The handle member extends from the distal end portion of the socket member. The handle member is substantially hollow for allowing the electrical line to pass therethrough.

Further, the handle member of the socket wrench includes a nut member disposed on a free end portion thereof. The nut member facilitates holding of the socket wrench by a socket wrench driver.

These together with the other aspects of the present disclosure, along with the various features of novelty that characterized the present disclosure, are pointed out with particularity in the claims annexed hereto and form a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, in which:

FIG. 1 illustrates a perspective view of a socket wrench, in accordance with an embodiment of the present disclosure;

FIG. 2 illustrates a cross sectional view of the socket wrench taken along a line A-A shown in FIG. 1; and

FIG. 3 illustrates a perspective view of the socket wrench of FIGS. 1 and 2 being utilized for driving a fastener associated with an electrical line, in accordance with an embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms “a” and “an” herein do not denote a limitation of quantity, but rather denote the presence of at least one of the referenced item.

The present disclosure provides a socket wrench for driving a fastener associated with an electrical line. Suitable examples of the fastener as mentioned herein may include a nut, a bolt and the like. However, the present disclosure is explained with reference to a nut. Further, it should be understood that the term ‘fastener associated with an electrical line,’ as mentioned herein and throughout the present disclosure may refer to a fastener installed in an electrical line. As is known to a person skilled in the art, the fastener may encapsulate an electrical connector connected to an electrical element, such as a connecting wire or an electrical cable.

The disclosed socket wrench includes a socket member and a handle member, each having a hollow construction for allowing an electrical line to pass therethrough. The socket member includes a socket head and a base member. The socket head is configured to receive the fastener associated with the electrical line. The base member includes an aperture configured therein that allows the electrical line to pass therethrough. Moreover, the handle member is substantially hollow for allowing the electrical line to pass therethrough. Upon receiving the fastener in the socket member and thereafter passing the electrical lines through the aperture, the socket wrench may be rotated for driving the fastener. Accordingly, the disclosed socket wrench may be utilized for driving the fastener without cutting or disengaging the electrical line. Moreover, the socket wrench may be rotated by means of a conventional socket wrench driver; thereby facilitating driving of the fastener in confined spaces, such as compact electrical enclosures that accommodate the electrical lines.

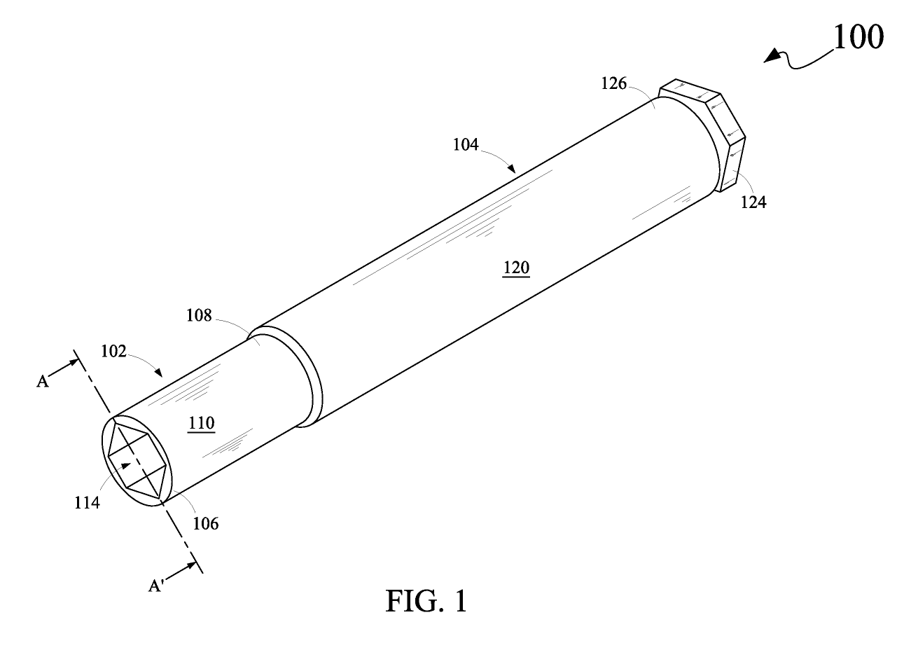

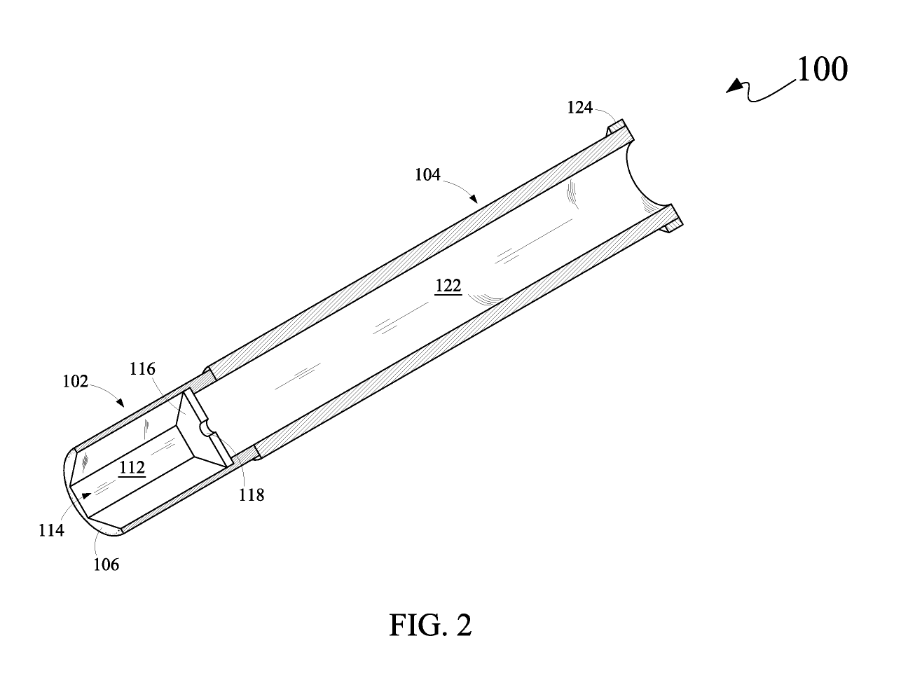

Referring now to FIG. 1 and FIG. 2, a socket wrench 100 is illustrated, in accordance with an embodiment of the present disclosure. Specifically, FIG. 1 depicts a perspective view of the socket wrench 100, and FIG. 2 depicts a cross sectional view of the socket wrench 100 taken along a line A-A shown in FIG. 1. The socket wrench 100 may be utilized for driving fasteners (not shown in FIG. 1 and FIG. 2) associated with electrical lines (not shown in FIG. 1 and FIG. 2).

The socket wrench 100 includes a socket member 102 and a handle member 104. The socket member 102 may have a tubular structure having a proximal end portion 106 and a distal end portion 108. Moreover, the socket member 102 includes an outer peripheral surface 110 and an inner peripheral surface 112 (shown in FIG. 2). In an embodiment of the present disclosure, the outer peripheral surface 110 of the socket member 102 is substantially circular, while the inner peripheral surface 112 is polygonal. The outer peripheral surface 110 is shown and described to be circular in shape. The circular shape facilitates ease of handling of the socket member 102. However, it will be evident to a person skilled in the art that the outer peripheral surface 110 may assume any other shape such as a polygonal shape without departing from the scope of the present disclosure. In an embodiment of the present disclosure, the outer peripheral surface 110 may include a corrosion resistant coating (not shown).

The inner peripheral surface 112 is hereby shown and described to be polygonal, thereby ensuring receiving of a polygonal fastener therein. However, it will be understood to a person skilled in the art that the inner peripheral surface 112 of the socket member 102 may be made in other shapes as well without departing from the scope of the disclosure. Further, the inner peripheral surface 112 may include an insulating lining (not shown) of a material which is a bad conductor of electricity.

The socket member 102 includes a socket head 114 and a base member 116. Specifically, the polygonal inner peripheral surface 112 of the socket member 102 configures the socket head 114 extending between the proximal end portion 106 and the distal end portion 108 thereof. It should be apparent to a person skilled in the art that the term socket head 114 as mentioned herein connotes a component, which ensures receiving of a fastener, such as a nut, a bolt, and the like therein. The length of the socket head 114 is sufficient to substantially or completely receive the fastener. In one embodiment of the present disclosure, the size of the socket head 114 is about half inch to about three inches.

The base member 116 is configured at the distal end portion 108 of the socket member 102. The base member 116 forms the base of the hollow socket member 102. The base member 116 includes an aperture 118 configured at a substantially central portion thereof. The aperture 118 facilitates the electrical line having the fastener installed thereon, to pass through the aperture. The size of the aperture 118 is larger than that of the electrical line. In the present embodiment, the aperture 118 is depicted circular in shape, however the aperture 118 can be rectangular, polygonal and the like, without departing from the scope of the disclosure.

The handle member 104 extends from the distal end portion 108 of the socket member 102. Specifically, the handle member 104 may be welded to the distal end portion 108 of the socket member 102. The handle member 104 may be substantially hollow for allowing the electrical line to pass therethrough. The handle member 104 includes an external surface 120 and an internal surface 122 (shown in FIG. 2). The external surface 120 of the handle member 104 may include a corrosion resistant coating (not shown). Moreover, the internal surface 122 may include an insulating lining (not shown) of a material that is a bad conductor of electricity. In an embodiment of the present disclosure, the length of the handle member 104 is sufficient to facilitate handling of the handle member 104 from outside the electrical enclosure. Accordingly, the handle member 104 may be utilized for manually driving the fastener. In an exemplary embodiment, the diameter of the handle member 104 is about 1 inch. In another exemplary embodiment, the diameter of the handle member 104 is about 1.25 inches.

In an embodiment of the present disclosure, the handle member 104 includes a nut member 124 disposed on a free end portion 126 of the handle member 104. The nut member 124 facilitates holding of the socket wrench 100 by a socket wrench driver, such as a conventional wrench (not shown).

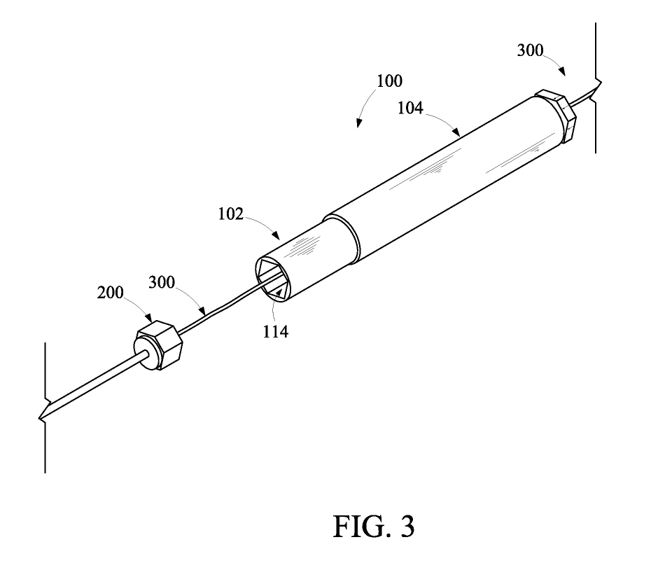

The handle member 104 and the socket member 102 may be composed of a metal, such as Iron. In an embodiment of the present disclosure, the handle member 104 and the socket member 102 are composed of an alloy, for example steel. The handle member 104 and the socket member 102 may be composed of a light weight material, thereby making the socket wrench 100 light weight and convenient to transport. An exemplary application of the socket wrench 100 utilized in electrical line is described in conjunction with FIG. 3.

FIG. 3 illustrates an exemplary application of the socket wrench 100. More specifically, FIG. 3 depicts the socket wrench 100 being utilized for driving a fastener 200 associated with an electrical line 300. Specifically, the fastener 200 is installed in the electrical line 300. The socket head 114 of the socket member 102 is adapted to receive the fastener 200. The aperture 118 (shown in FIG. 2) enables the electrical line 300 to pass therethrough. Further, the handle member 104 being hollow allows the electrical line 300 to pass therethrough. Upon receiving the fastener 200 in the socket head 114 and passing the electrical line 300 through the aperture 118 and the handle member 104, the socket member 102 of the socket wrench 100 may be driven by means of a socket wrench driver (not shown), thereby driving the fastener 200 received in the socket head 114.

The present disclosure provides a socket wrench which offers the following advantages. The socket wrench includes a socket member and a handle member, each having a hollow construction. The hollow construction of the socket member and the handle member allows an electrical line with a faster installed thereon to pass through the socket wrench. Accordingly, the socket wrench facilitates driving of a fastener installed on an electrical line without cutting or disengaging the electrical line. Moreover, driving of the fastener without cutting the electrical line saves considerable time and effort. Additionally, the handle member facilitates driving of the fastener even from outside the electrical enclosures without disturbing other electrical components installed within the electrical enclosures.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A socket wrench for driving a fastener associated with an electrical line, the socket wrench comprising:
a socket member having a proximal end portion and a distal end portion, the socket member comprising
a socket head extending between the proximal end portion and the distal end portion of the socket member, the socket head configured to receive the fastener, and
a base member configured at the distal end portion of the socket member, the base member having an aperture configured therein, the aperture capable of allowing the electrical line to pass therethrough; and
a handle member extending from the distal end portion of the socket member, the handle member being substantially hollow for allowing the electrical line to pass therethrough.

3. The socket wrench of claim 1, wherein each of the socket member and handle member is composed of a metal.

4. The socket wrench of claim 1, wherein each of the socket member and handle member is composed of an alloy.

5. The socket wrench of claim 1, wherein the fastener is one of a nut and a bolt.

6. The socket wrench of claim 1, wherein the socket member comprises an outer peripheral surface and an inner peripheral surface, the outer surface being substantially circular, and the inner peripheral surface being polygonal for receiving the fastener.

7. The socket wrench of claim 1, wherein a free end portion of the handle member comprises a nut member, the nut member facilitating holding of the socket wrench by a socket wench driver.
